(19) United States
(12) Patent Application Publication
(10) Pub. No.: US 2009/0256453 A1
(43) Pub. Date: Oct. 15, 2009

(54) LATCH-TYPE LOCATING DEVICE

(75) Inventors: Ting-Jui Wang, Sindian City (TW); Ming-De Wu, Sindian City (TW)

Correspondence Address: SCHMEISER, OLSEN & WATTS, 22 CENTURY HILL DRIVE, SUITE 302, LATHAM, NY, 12110, US

(73) Assignee: FIVETECH TECHNOLOGY INC., Sindian City (TW)

(21) Appl. No.: 12/102,986

(22) Filed: Apr. 15, 2008

(51) Int. Cl. E05C 17/62

(52) U.S. Cl. 312/222

(57) ABSTRACT

A latch-type locating device including an outer sleeve having an annular engaging section formed at a front end thereof; an inner sleeve movably telescoped in the outer sleeve; a linking unit including a connecting rod located in the outer sleeve, an actuating rod connected to a front end of the connecting rod and fitted in the inner sleeve to interfere with the same, and a flange formed at a rear end of the connecting rod; a cap member being engaged with the flange of the linking unit; and an elastic element fitted around the connecting rod of the linking unit. The inner sleeve may be driven by the cap member and linking unit to extend from or retract into the outer sleeve to thereby lock an article in place or release the article.

### FIELD OF THE INVENTION

The present invention relates to a latch-type locating device having an outer sleeve, an inner sleeve movably telescoped in the outer sleeve, and a linking unit for driving the inner sleeve to extend from or retract into the outer sleeve. The inner sleeve in the extended position may hold an object ina fixed position, and the inner sleeve in the retracted position may release the object.

### BACKGROUND OF THE INVENTION

Many things used in people's daily life, such as servers, cabinets, racks, etc., usually include one or more carrier units, such as chassis, drawers, and shelves for accommodating relevant articles therein. These carrier units are often provided with slide rails, and can therefore be slidably drawn out and pushed in along corresponding slide channels, allowing users to easily position or remove things therein or therefrom for storage or necessary processing. Stop plates are generally positioned between the slide rails and the slide channels to restrict the slide rails to slide only within the slide channels without becoming separating therefrom.

However, while the stop plates can avoid separation of the slide rails from the slide channels, there is not any locating member provided between the slide rails and the slide channels at a specific position. Therefore, the carrier units can only be fully drawn out or fully pushed in along the slide channels without the possibility of being temporarily locked to a certain predetermined position, such as halfway of the slide channels. Consequently, in case of earthquake, vibration, broken slide rail, or inclined floor, the carrier units tend to unexpectedly slide out of the server, the cabinet, or the rack and lead to damage of the things accommodated in the carrier units.

### SUMMARY OF THE INVENTION

It is therefore a primary object of the present invention to provide a handy latch-type locating device including an outer sleeve, an inner sleeve, and a linking unit. The linking unit serves to drive the inner sleeve to extend from the outer sleeve to hold a predetermined object in place, or retract into the outer sleeve to release the object.

According to the above object, the latch-type locating device of the present invention includes an outer sleeve having two flat sections oppositely formed on an outer circumference of the outer sleeve, and an annular engaging section formed at a front end of the outer sleeve; an inner sleeve movably telescoped in the outer sleeve; a linking unit including a connecting rod located in the outer sleeve, an actuating rod connected to a front end of the connecting rod and fitted in the inner sleeve to interfere with the same, and a flange formed at a rear end of the connecting rod; a cap member being engaged with the flange of the linking unit and having two protruded sections oppositely formed on an inner circumference of the cap member corresponding to the two flat sections of the outer sleeve; and an elastic element being fitted around the connecting rod of the linking unit with two ends of the elastic element respectively abutted against a rear inner end of the outer sleeve and a rear outer end of the inner sleeve.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of the present invention;

FIG. 2 is an assembled perspective view of the present invention;

FIG. 3 is a sectioned side view of the present invention, showing that an actuating rod is impacted and flared at a front end to interfere with an inner sleeve;

FIG. 4 is a phantom perspective view showing the mounting of the present invention to a server rack for holding a plurality of server chassis thereto;

FIG. 5 is a sectional view showing the inner sleeve of the present invention is outward extended from an outer sleeve into a locating hole on the server chassis to stop the server chassis from moving relative to the server rack; and

FIG. 6 is a sectional view according to FIG. 5, showing the inner sleeve of the present invention is retracted into the outer sleeve to release the server chassis.

### DETAILED DESCRIPTION OF THE PREFERRED EMBODIMENTS

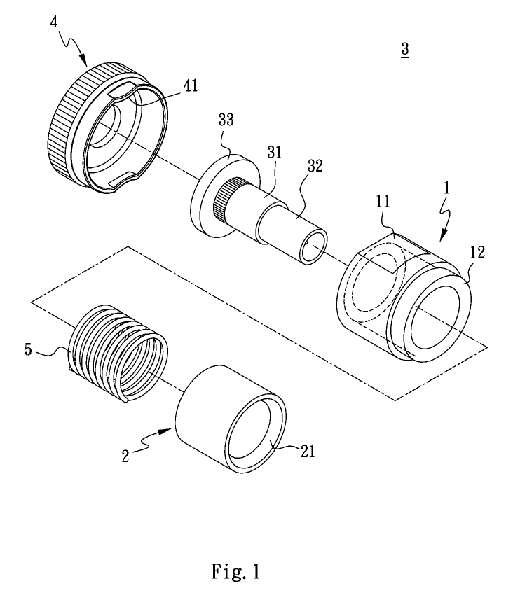

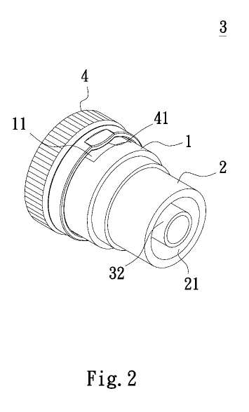

Please refer to FIGS. 1 and 2 that are exploded and assembled perspective views, respectively, of a latch-type locating device according to an embodiment of the present invention. As shown, the latch-type locating device of the present invention includes an outer sleeve 1, an inner sleeve 2, a linking unit 3, a cap member 4, and an elastic element 5.

Two flat sections 11 are oppositely formed on an outer circumference of the outer sleeve 1. In addition, an annular engaging section 12 is formed at a front end of the outer sleeve 1.

The inner sleeve 2 is movably telescoped in the outer sleeve 1. An inner circumference of a front end of the inner sleeve 2 is formed with a beveled section 21.

The linking unit 3 includes a connecting rod 31 located in the outer sleeve 1, an actuating rod 32 connected to a front end of the connecting rod 31 and fitted in the inner sleeve 2, and a flange 33 formed at a rear end of the connecting rod 31. The actuating rod 32 has an outer diameter smaller than that of the connecting rod 31 to define a shoulder section between the actuating rod 32 and the connecting rod 31.

The cap member 4 is engaged with the flange 33 of the linking unit 3. Two protruded sections 41 are oppositely formed on an inner circumference of the cap member 4 corresponding to the two flat sections 11 of the outer sleeve 1.

The elastic element 5 is positioned in the outer sleeve 1 and fitted around the connecting rod 31 of the linking unit 3. Two ends of the elastic element 5 respectively abut against a rear inner end of the outer sleeve 1 and a rear outer end of the inner sleeve 2.

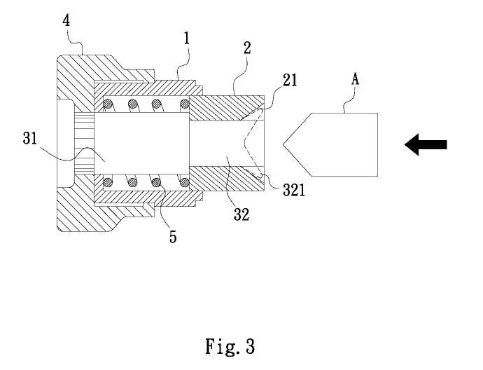

Please refer to FIGS. 3 to 6. After the above components are assembled together to form a complete latch-type locating device of the present invention, a front end of the actuating rod 32 of the linking unit 3 is impacted using a tool A, so that the front end of the actuating rod 32 is expanded and flared toward the beveled section 21 of the inner sleeve 2 to form an interference section 321, via which the actuating rod 32 interferes with the inner sleeve 2, enabling the linking unit 3 to drive the inner sleeve 2 to move along with the linking unit 3.

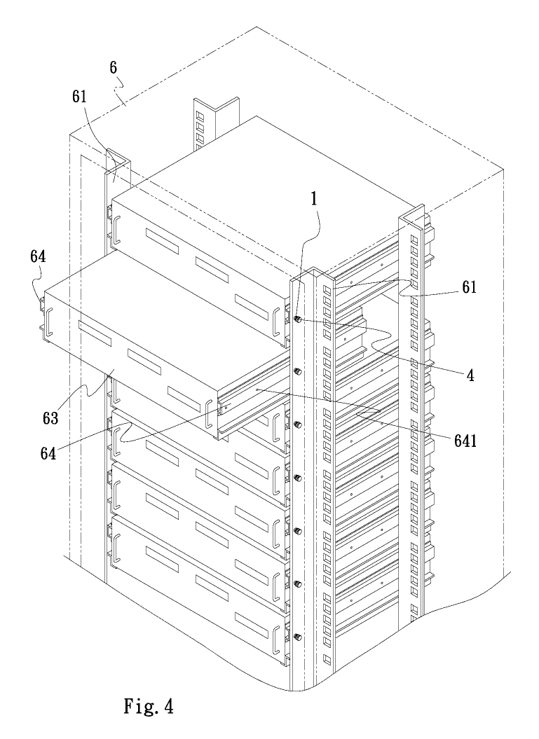

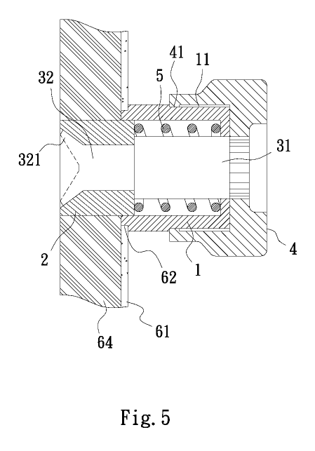

Referring to FIG. 4, a plurality of latch-type locating devices of the present invention may be mounted on a server rack 6 in pairs or independently for use. The server rack 6 has at least two pairs of symmetrically arranged side posts 61, each of which is formed with a plurality of through holes 62. A plurality of server chassis 63 may be slidably superposed in the server rack 6. Each of the server chassis 63 is provided at two lateral sides with a slide rail 64 each. The slide rail 64 is formed at predetermined positions with several locating holes 641. Referring now to FIG. 5, by way of tight fit, welding, riveting, bonding, or any other equivalent measures, the engaging section 12 of the outer sleeve 1 may be fixed in the through hole 62 of the side post 61. At this point, the inner sleeve 2 is pushed by the elastic element 5 to retractably extend through the through hole 62 into one of the locating holes 641 on the slide rail 64 of the server chassis 63. As a result, the server chassis 63 is immovably held to the side posts 61 without the possibility of sliding relative to the server rack 6.

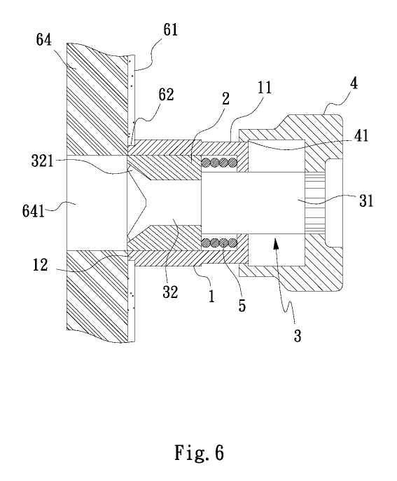

When it is desired to release any of the server chassis 63 from the server rack 6, a user can pull the cap member 4 to axially slide the protruded sections 41 thereof along the flat sections 11 of the outer sleeve 1. Simultaneously, with the flange 33 engaged with the cap member 4, the linking unit 3 is driven by the cap member 4 to move along with the cap member 4, whereby via the interference section 321 abutted against the beveled section 21 of the inner sleeve 2, the actuating rod 32 pulls the inner sleeve 2 out of the locating hole 641. At this point, the inner sleeve 2 is retracted into the outer sleeve 1 to compress the elastic element 5 as shown in FIG. 6. Under this circumstance, the slide rail 64 of the server chassis 63 is released from the holding by the inner sleeve 2, permitting a user to draw or push the server chassis 63 out of or into the server rack 6 along the slide rail 64. After pulling the cap member 4, the user may further rotate the cap member 4 by a preset angle to turn the protruded sections 41 aside from the flat sections 11 of the outer sleeve 1. In this manner, the protruded sections 41 are immovably stuck to the outer circumference of the outer sleeve 1 to thereby hold the inner sleeve 2 in the outer sleeve 1. Under such circumstance, the inner sleeve 2 is hindered from extending out of the outer sleeve 1 and the user can let go the cap member 4.

When the server chassis 63 is drawn or pushed to a predetermined position with one of the locating holes 641 on the slide rail 64 in alignment with the through hole 62 on the side post 61, the user may turn the cap member 4 reversely and release the same. At this point, the elastic element 5 elastically restores to its home position and applies an elastic force onto the inner sleeve 2 to push the same out of the outer sleeve 1 into the locating hole 641, so that the server chassis 63 is again held by the inner sleeve 2 to a fixed position.

In practice, the present invention is also applicable to anything having drawers or shelves, such as general lockers, cabinets, etc.

With the above arrangements, the latch-type locating device of the present invention uses an inner sleeve and a linking unit slidably received in an outer sleeve to quickly lock a sliding article in place or release the sliding article from a locked state to thereby effectively overcome the problems in the prior art products.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A latch-type locating device, comprising:
an outer sleeve having two flat sections oppositely formed on an outer circumference of the outer sleeve, and an annular engaging section outward extended from a front end of the outer sleeve;
an inner sleeve movably telescoped in the outer sleeve;
a linking unit including a connecting rod located in the outer sleeve, an actuating rod connected to a front end of the connecting rod and fitted in the inner sleeve to interfere with the same, and a flange formed at a rear end of the connecting rod;
a cap member being engaged with the flange of the linking unit, and having two protruded sections oppositely formed on an inner circumference of the cap member corresponding to the two flat sections of the outer sleeve; and
an elastic element being positioned within the outer sleeve and fitted around the connecting rod of the linking unit, and two ends of the elastic element being respectively abutted against a rear inner end of the outer sleeve and a rear outer end of the inner sleeve.

2. The latch-type locating device as claimed in claim 1, wherein the inner sleeve is formed at an inner circumference of a front end thereof with a beveled section corresponding to a flared front end of the actuating rod.

3. The latch-type locating device as claimed in claim 1, wherein the actuating rod of the linking unit has an outer diameter smaller than that of the connecting rod to define a shoulder section between the actuating rod and the connecting rod.
